(19) United States
(12) Patent Application Publication
(10) Pub. No.: US 2019/0224549 A1
(43) Pub. Date: Jul. 25, 2019

(54) SPORTS TRAINING DEVICE

(71) Applicant: Tyrell Rashawn Grant, Spotswood, NJ (US)

(72) Inventor: Tyrell Rashawn Grant, Spotswood, NJ (US)

(21) Appl. No.: 15/890,279

(22) Filed: Feb. 6, 2018

Related U.S. Application Data
(60) Provisional application No. 62/619,971, filed on Jan. 22, 2018.

(51) Int. Cl. A63B 69/00; F16B 7/10

(52) U.S. Cl. CPC A63B 69/0071; A63B 2243/0037; F16B 7/105

(57) ABSTRACT

A training device comprising a plurality of arms, each arm having two or more markings, the two or more markings being disposed at a position that is related to one of (a) a type of maneuver to be practiced, (b) anthropometric data of typical players, (c) anthropometric data of a specific player performing an exercise, and (d) a diameter of a basketball, and at least one junction, each junction being disposed between each pair of the plurality of arms, and a base coupled to each of the at least one junction.

### CROSS-REFERENCE TO RELATED APPLICATION

The present application claims priority to U.S. Provisional Patent Application Ser. No. 62/619,971 entitled “SPORTS TRAINING DEVICE”, filed on Jan. 22, 1018, the contents of which is hereby incorporated by reference in its entirety as if fully set forth herein.

### FIELD OF THE DISCLOSURE

The present disclosure relates to sports training equipment. More particularly the present disclosure relates to a device to help perform certain exercises to improve skill and/or coordination when playing a sport, such as basketball.

### BACKGROUND OF THE DISCLOSURE

Improving skill typically requires hundreds or thousands of hours of practice. Repetition helps build muscle memory and sharpens reflexes, which improve performance. Unfortunately, practicing improper technique may actually damage a player's skill, and in some cases, may lead to a risk of injury. For example, dribbling a basketball at an incorrect height may lead to an increase in turnovers. To combat this, trainers and coaches have begun to place an increased emphasis on proper technique and fundamentals.

In most cases, the trainer and/or coach must repeatedly show a player how to properly perform a specific move or maneuver. Because such trainers and/or coaches are not available at all times, players often forget the proper technique and revert to bad habits. Additionally, it is often difficult for a trainer or coach to pay attention to a team of players and ensure that each player is practicing correctly. Thus, it would be beneficial to have training equipment that reinforces proper technique.

### SUMMARY OF THE DISCLOSURE

In some embodiments, a training device includes a plurality of arms, each arm having two or more markings, the two or more markings being disposed at a position that is related to one of (a) a type of maneuver to be practiced, (b) anthropometric data of typical players, (c) anthropometric data of a specific player performing an exercise, and (d) a diameter of a basketball, and at least one junction, each junction being disposed between each pair of the plurality of arms, and a base coupled to each of the at least one junction.

In some examples, a training device includes at least one arm having two or more markings, and at least one base coupled to the at least one arm and capable of elevating the at least one arm above the ground by a predetermined height.

### BRIEF DESCRIPTION OF THE DISCLOSURE

Various embodiments of the presently disclosed connectors are disclosed herein with reference to the drawings, wherein:

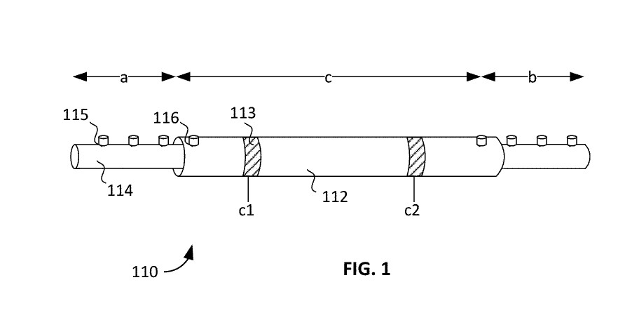

FIG. 1 is a schematic side view of a telescoping arm for a training device;

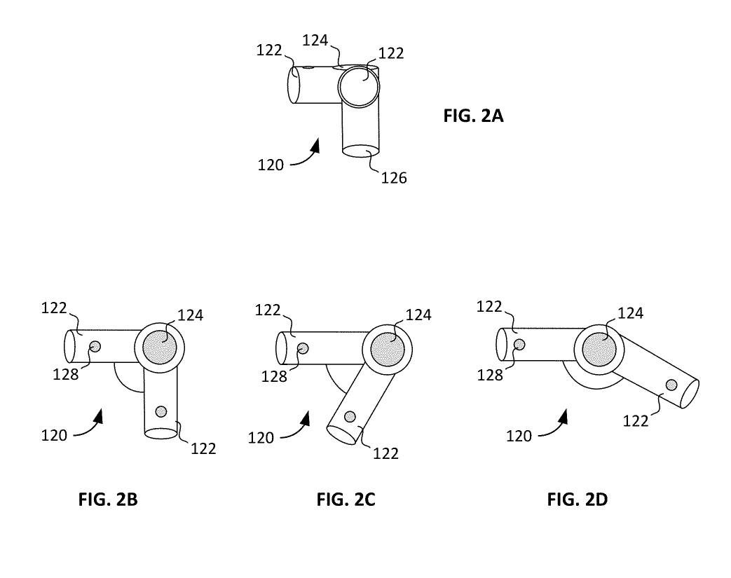

FIG. 2A is schematic side view of a junction for a training device;

FIGS. 2B-D are schematic top view of the junction of FIG. 2A in various configurations;

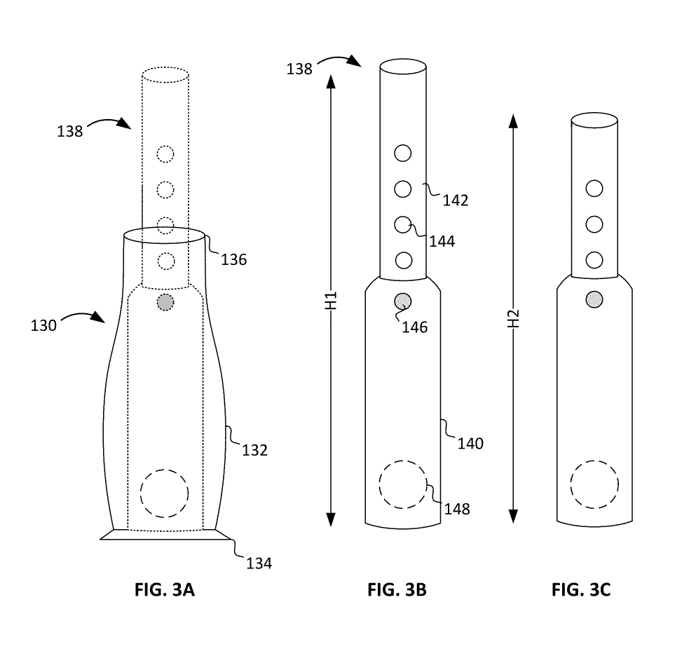

FIGS. 3A-C are schematic side views of a base for use with a training device, and the post for use within the base;

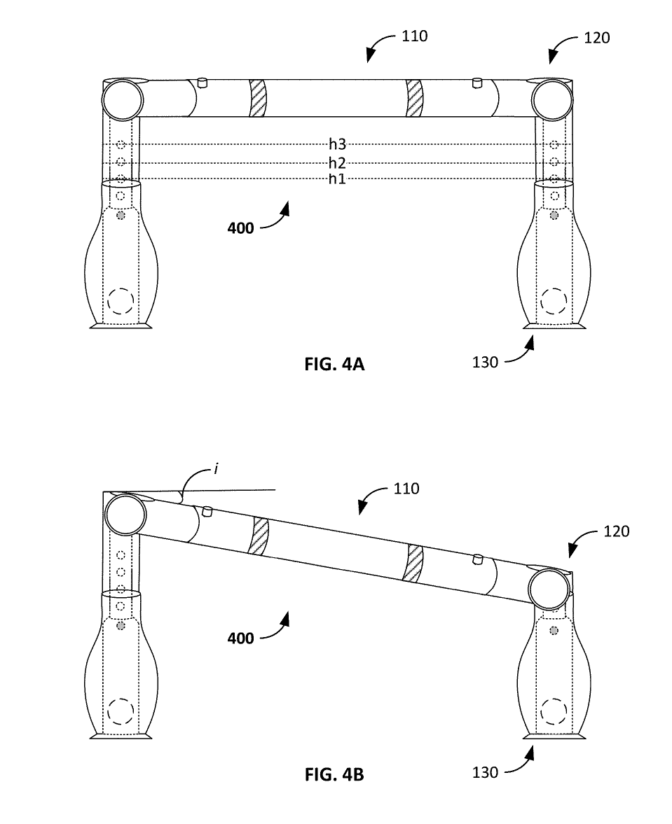

FIG. 4A is a schematic top view of one example of an assembled training device in a first configuration;

FIG. 4B is a schematic top view of one example of an assembled training device in a second configuration; and

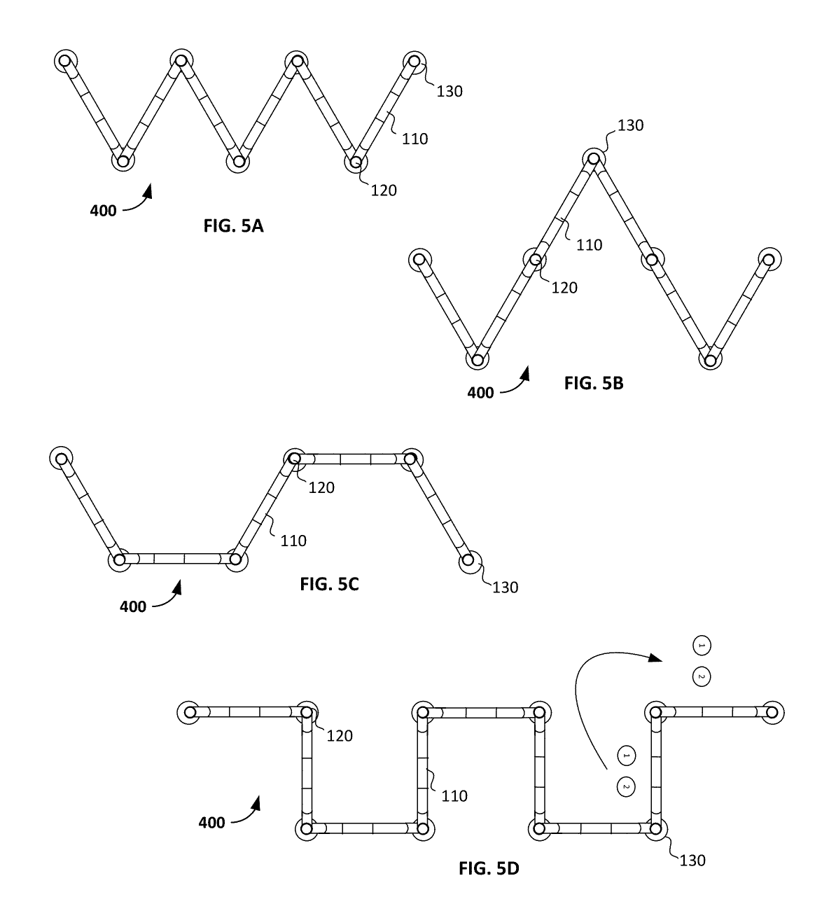

FIGS. 5A-D are schematic top views of training devices in various configurations.

Various embodiments of the present invention will now be described with reference to the appended drawings. It is be appreciated that these drawings depict only some embodiments of the invention and are therefore not to considered limiting of its scope.

### DETAILED DESCRIPTION

Despite the various improvements that have been made to sports training and equipment, conventional methods suffer from some shortcomings as discussed above.

There therefore is a need for further improvements to the devices and methods used to improve the skills of athletes, such as football players, soccer player, tennis player and basketball players in particular. Although many of the examples described herein are detailed in connection with the game of basketball, it will be understood that the principles of the disclosure are equally applicable to other sports. Among other advantages, the present disclosure may address one or more of these needs.

A training device may generally include at least one of a telescoping arm, a junction and a base. Each of these three components will be described separately, and the assembled device will then be detailed thereafter.

FIG. 1 illustrates a telescoping arm 110 for use in the sports training device. Telescoping arm 110 generally includes a central portion 112 disposed between a pair of extendable sections 114. Central portion 112 may be formed of a rigid or semi-rigid material that does not bend. Alternatively, central portion 112 may be flexible. In some examples, central portion 112 may be formed of a metallic, plastic, or polymeric rod. For example, central portion 112 may be formed of common PVC piping. Central portion 112 may be substantially hollow or solid. In some examples, instead of a rigid component, central portion 112 may be replaced with a rope, thread, twine or other similar materials.

The arm may include extendable sections formed of a material that is similar to or different from the central portion 112. Extendable sections 114 may be slightly smaller in diameter than central portion 112 and may be capable of telescoping therein. Extendable sections 114 may also include a number of projecting spring-loaded pins 115 that are biased to project out of the sections. Relatedly, central portion 112 may include an aperture 116 on each side sized to receive a pin 115 of extendable section 114. Thus, the length of extendable section “a” may be changed by choosing which pin of the section locks within the aperture of the central portion. The second extendable section on the opposite side of central portion 112 may be likewise adjustable, and its length “b” may be adjusted to be equal to length “a” of the first section.

Central portion 112 may have a length “c” as shown. In at least some examples, the total length of the telescoping arm 110 (e.g., a+b+c) may be adjustable between 1 foot and 6 feet. In at least some specific examples, the total length of the telescoping arm 110 may be between 2 and 4 feet.

Central portion 112 may also include one or more markings 113 disposed on its outer surface as shown. In at least some examples, markings 113 are in the form of a score, a piece of plastic, an adhesive sticker, or a portion of tape circumferentially disposed on the central portion. It will be understood that any number of markings may be used as desired. For example, in some examples, each central portion 112 includes a single marking 113. Alternatively, two, three, four or more markings 113 are used on each central portion.

As shown, central portion 112 includes two markings 113 disposed at positions c1 and c2. The positions of the markings (e.g., positions c1 and c2) may be chosen based on (a) the type of maneuver to be practiced (e.g., a crossover in basketball), (b) anthropometric data of typical players (e.g., the arm span of an average player), (c) anthropometric data of the specific player performing the exercise, (d) the diameter of the basketball or (e) a combination of any of these factors. For example, the distance between positions c1 and c2 may be equal to the length of the player's shoe size. In another example, the distance between positions c1 and c2 may be equal to the distance between the player's knees so that the knees are aligned with the markings when the player is facing the arm. In such cases, the distance between positions c1 and c2 may be equal to the distance between a specific player's knees, or the distance may be based on an average distance of a group of players. Alternatively, the distance between positions c1 and c2 may be equal to the diameter of a basketball or a factor thereof (e.g., 120% of the diameter of a basketball). Thus, the number of markings and positions of markings may be chosen to improve a skill as will be discussed below.

In some additional examples, markings 113 may be formed of translatable rings that are disposed around central portion 112, the position of the rings being moveable along the length of the central portion 112 so that the user or player can decide where to place the markings. Thus, the markings may be adjusted based on the size of the athlete.

Multiple telescoping arms 110 may be connected together via junctions 120 (FIG. 2A). Each junction 120 may include or more horizontal receptacles 122 having lumens for receiving a portion of the telescoping arms, and a vertical receptacle 126 having a lumen for receiving a portion of a post to form a 3-way elbow as will be discussed below. In at least some examples, a junction 120 may include two, three, four, five or six horizontal receptacles 122 to receive portions of two, three, four, five or six telescoping arms 110 as desired. Alternatively, a junction may only include a single horizontal receptacle 122 to receive a portion of a single telescoping arm 110 and serve as an end cap.

A button 124 may be disposed between the horizontal receptacles 122, the button being depressible to change the angle between the horizontal receptacles. For examples, as shown in FIG. 2B-D, the top view of the same junction is shown in various configurations. In FIG. 2B, the two horizontal receptacles 122 are disposed approximately 90 degrees apart. In FIG. 2C, the two horizontal receptacles 122 are disposed approximately 60 degrees apart, and in FIG. 2D, the receptacles are 135 degrees apart. Thus, the user may adjust the position of the receptacles relatively to one another by pressing the button, the receptacles being moveable to any configuration between 0 degrees and 180 degrees relative to one another. Adjusting the angle between horizontal receptacles will also change how telescoping arms are aligned with one another. Optionally, each receptacle of junctions 120 includes slots 128 for accepting at least one pin 115 of the extendable section 114 of a telescoping arm so that the telescoping arm and the junction are secured together and do not come apart during an exercise.

FIGS. 3A-C illustrate a base for use with the telescoping arms and junctions described above. In many exercises, the telescoping arm needs to be elevated above the ground. For example, in basketball drills, the telescoping arms may be used to simulate the reach of a defender. In such a case, the arms may be placed a position to show how a player should dribble the ball. Base 130 accomplishes this task. Base 130 generally includes a housing 132 having a suction cup 134 on its bottom to secure the base to a floor (e.g., a hardwood floor of a basketball court), and an opening 136 opposite the suction cup 134. Housing 132 is generally shaped as a bowling pin in this embodiment, having a wide base adjacent the suction cup 134 and a narrowed neck. It will be understood that housing 132 may take on other shapes. For example, housing 132 may be in the shape of a basketball to enhance aesthetics, or a football-type pylon.

Opening 136 of housing 132 may be large enough to receive a post 138 as shown. Disposed within housing 132 is a post 138 having a pedestal 140 and a vertical extension 142. Vertical extension 142 may also be configured to mate with a portion of junction 120. As shown, pedestal 140 has an opening 146, and vertical extension 142 having a number of spring-loaded post pins 144 so that the height of the post may be adjusted by selecting which pin is secured within opening 146. For example, the same post is shown in FIGS. 3B and 3C having heights H1 and H2. In some examples, post 138 may be adjustable in height between 6 inches and 3 feet inches. In most exercises, post 138 may be set to have a height of approximately 1.5 feet. In at least some examples, the height of base 130 should be approximately equal to a position within six inches of the athlete's knee (e.g., the height of the player's knee off the ground+/−six inches). Optionally, pedestal 140 includes a hole 148 for accepting a portion of an arm 110 and/or a junction 120 so that the arm is only a few inches off the ground. The hole 148 may be disposed at various positions along the pedestal. Thus, in at least some examples, the arm may be placed directly into the hole 148 of the pedestal, or coupled to the hole 148 via a junction 120 so that the arm is touching the floor, or so that the arm is only 0.5 inches to 2 inches off the floor. In these examples, the player may use the arm as guide by stepping over or across various arms to perform drills with or without the ball. Also, it will be understood that although the base, post and pedestal have been described as separate elements, variations of the device are possible in which the elements are unitarily formed.

FIG. 4A shows a side view of an assembled training device 400 in a first configuration, the device having a single telescoping arm 110, a pair of junctions 120 disposed on either side of the telescoping arm and a pair of bases 130, each base being attached to one of the junctions. As discussed, telescoping arm 110 has been elevated to a height of 3 feet off the floor, and adjustment of the height of the vertical extension of the post is capable of reducing the height of the telescoping arm 110 to between 3 inches and 3 feet. In at least some configurations, the height of telescoping arm 110 is sufficient to allow a basketball to be dribbled underneath it and have the ball travel from the athlete's first hand to the athlete's second hand under the telescoping arm in a position that is low enough so as not to be stolen or intercepted by a defender. Thus, the apparatus mimics game situations and the height may be adjusted as shown by the dashed lines labeled, h1, h2, h3 etc.

As shown in FIG. 4B, two bases carrying a telescoping arm may be adjusted to different heights so that the telescoping arm is disposed on an incline. In the example shown, telescoping arm forms an angle “i” of approximately 10 degrees with respect to the floor. It will be understood that by adjusting the heights of the bases and the length of the arm, the angle “i” of the arm may be adjusted anywhere between 0 degrees and 60 degrees with respect to the floor.

One telescoping arm 110 is suspended in FIGS. 4A and 4B between two bases 130. In order to perform more complex exercises such as multiple dribbling maneuvers including cross-overs, spins, between the legs, etc., multiple telescoping arms 110 may be attached together to form circuits as shown in the overhead views of FIG. 5A-D. For example, FIG. 5A shows a six-segment circuit of six telescoping arms 110 arranged in a zig-zag configuration, propped up by seven bases 130. In this configuration, the same angle is formed between adjacent pairs of telescoping arms. FIG. 5B shows the same device of six telescoping arms 110 and seven bases 130 being formed in a W-shaped configuration. In FIG. 5C, one telescoping arm and one base has been removed to form the undulating configuration shown. In FIG. 5D, nine telescoping arms are used to form a long circuit of various ninety-degree angles. As shown in FIG. 5D, the markings on the various arms may be disposed so that the player may align with a first pair of markings and spin to align with another pair of markings. As shown, two circles marked “1” and “2” indicate where the player's feet will be initially located. These two feet are aligned with two markings of a first arm. After the user spins to the second position as shown by the arrow, the new locations of the feet shown with circles marked “1” and “2” indicate that the player is now aligned with a first marking on a second arm. Thus, the markings and arms may be disposed in locations so that a spin, a crossover, or another maneuver results in the player being aligned with one or more of the markings. By repeating the maneuver repeatedly and aligning with the markings on the arm, the player's skills will improve. Moreover, the system is modular to allow a circuit to be formed in any length and to have any number of arms as desired.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. For example, instead of discrete telescoping arm, a unitary member having one or more curves or angles may be used to, the unitary member being suspended by one more bases. For example, a single W-shaped member may replace the six arm configuration of FIG. 5B. Alternatively, a rope or tether may be passed through or around apertures in one or more bases to create flexible dividers to replace the telescoping arms. Additionally, though all of the telescoping arms have been shown in the same length, a circuit may be created using telescoping arms of different lengths. Likewise, though the same height of bases are shown, multiple heights may be utilized so that the training device increases or decreases in height at certain portions of the circuit. Arms may also be directly coupled to bases or configured to lay flat on a base to eliminate the junctions.

It will be appreciated that the various dependent claims and the features set forth therein car be combined in different ways than presented in the initial claims. It will also be appreciated that the features described in connection with individual embodiments may be shared with others of the described embodiments.

What is claimed is:

1. A training device comprising:
at least one arm having two or more markings; and
at least one base coupled to the at least one arm and capable of elevating the at least one arm above the ground by a predetermined height.

2. The training device of claim 1, further comprising a junction coupled to the at least one arm, the junction being coupled to the at least one base so that the at least one arm and the at least one base are secured together via the junction.

3. The training device of claim 1, wherein the at least one arm includes a central portion and at least one extendable section.

4. The training device of claim 3, wherein the at least one extendable section includes two extendable sections disposed on opposite sides of the central portion.

5. The training device of claim 4, wherein each of the extendable arms includes a plurality of spring-loaded pins, the central portion includes an aperture for receiving one of the plurality of pins, and the extendable arms are capable of telescoping within the central portion.

6. The training device of claim 2, wherein the junction includes at least one horizontal receptacle for accepting a portion of the at least one arm, and a vertical receptacle for accepting a portion of the base.

7. The training device of claim 6, wherein the junction includes multiple horizontal receptacles, the first of the horizontal receptacles being capable of accepting a portion of the at least one arm, and others of the horizontal receptacles being capable of accepting other portions of additional arms.

8. The training device of claim 7, wherein the horizontal receptacles define an angle therebetween, and the junction further includes a button for adjusting the angle between the horizontal receptacles.

9. The training device of claim 1, wherein the at least one base includes a housing and a post disposed within the housing.

10. The training device of claim 9, further comprising a suction cup attached to the bottom of the housing.

11. The training device of claim 9, wherein the post includes a pedestal and a vertical extension, the vertical extension being translatable relative to the pedestal so that a height of the post is adjustable.

12. The training device of claim 9, wherein the vertical extension includes a number of spring-loaded pin.

13. The training device of claim 1, wherein the two or more markings are disposed on the at least one arm at a position that is related to one of (a) a type of maneuver to be practiced, (b) anthropometric data of typical players, (c) anthropometric data of a specific player performing an exercise, and, (d) a diameter of a basketball.

14. A training device comprising:
a plurality of arms, each arm having two or more markings, the two or more markings being disposed at a position that is related to one of (a) a type of maneuver to be practiced, (b) anthropometric data of typical players, (c) anthropometric data of a specific player performing an exercise, and (d) a diameter of a basketball; and
at least one junction, each junction being disposed between each pair of the plurality of arms; and
a base coupled to each of the at least one junction.

15. The training device of claim 14, wherein the plurality of arms includes five arms.

16. The training device of claim 14, wherein the plurality of arms includes six arms.

17. The training device of claim 14, wherein each base has an adjustable height.

18. The training device of claim 14, wherein the plurality of arms form a W-shaped circuit.

19. The training device of claim 14, wherein the plurality of arms form a zig-zag-shaped circuit.

20. The training device of claim 14, wherein the plurality of arms form a circuit having a number of ninety-degree angles.
